(19) United States
(12) Patent Application Publication
(10) Pub. No.: US 2005/0161856 A1
(43) Pub. Date: Jul. 28, 2005

(54) Extrusion jacketing process

(76) Inventors: Yevgeniy I. Globus, Littleton, MA (US); Mark A. Jozokos, Pelham, NH (US); John L. Netta, Newark, DE (US); George Martin Pruce, Glastonbury, CT (US); Sundar Kilnagar Venkataraman, Vienna, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/039,439

(22) Filed: Jan. 19, 2005

Related U.S. Application Data
(60) Provisional application No. 60/539,038, filed on Jan. 23, 2004.

(51) Int. Cl. B32B 15/04

(52) U.S. Cl. 264/171.14

(57) ABSTRACT

The present invention relates to the melt draw-down extrusion jacketing of plenum cable, wherein the jacket is a composition of tetrafluoroethylene/hexafluoropropylene copolymer containing at least 10 wt % of char-forming agent and preferably 0.1 to 5 wt % hydrocarbon polymer, wherein the extrusion is carried out at a draw ratio balance of less than 1.

### BACKGROUND OF THE INVENTION

1. Field of the Invention

This invention relates to the melt extrusion of tetrafluoroethylene (TFE)/hexafluoropropylene (HFP) copolymer.

2. Description of Related Art

Tetrafluoroethylene/hexafluoropropylene copolymer (FEP) is well known as wire insulation for twisted pairs of insulated wires that are assembled and jacketed to form plenum cable. Plenum cable is cable used for data and voice transmission that is installed in building plenums, i.e. the spaces above dropped ceilings or below raised floors that are used to return air to conditioning equipment. The cable comprises a core which performs the transmission function and a jacket over the core. Typical core constructions include a plurality of twisted pairs of insulated wires or coaxially-positioned insulated conductors. The FEP is capable of being extruded at high line speeds, exceeding 1000 ft/min (305 m/min) to form the primary insulation on the wire. DuPont product bulletin entitled “DuPont™ Teflon® FEP CJ-95” no. 248417A (January, 2002), discloses the use of Teflon® FEP CJ-95 having a melt flow rate (MFR) of 6 g/10 min for cable jacketing application and its processing at higher line speeds than its predecessor Teflon® FEP 140 resin. Line speed is the speed at which the wire being coated with the resin passes through the extruder crosshead, which corresponds to the rate at which the jacketed cable is wound up on a reel. The extrusion of FEP to form cable jacket is carried out at a much slower line speed than the line speed for insulating wire with FEP. The higher line speed made possible by the CJ-95 type enabled the line speed for forming cable jacket to reach 125 ft/min (38.1 m/min).

The above mentioned product bulletin provides extrusion operating conditions for the CJ-95 resin, namely draw down ratio (DDR) of 20 to 30:1 and draw ratio balance (DRB) of 1.08 to 1.15. DDR and DRB are further described in the DuPont:TEFLON®/TEFZEL® Melt Extrusion Guide”, no. H-45321 (April, 2001). As disclosed on p. 18, DDR is the ratio of the cross-sectional area of the annular die opening to the cross-sectional area of the finished insulation. The area of the latter is less than the area of the annular die opening by virtue of the melt extruded tube being drawn down onto the wire, the drawing down forming a molten cone of the resin. The higher wire speed as compared to the rate of extrusion of the tube causes a thinning out of the cone as it approaches the surface of the wire. DDR as applied to cable jacketing is measured the same way, with the core of the cable being substituted for the single wire being coated in the case of primary insulation. The cross-sectional area of the cable jacket is compared with the cross-sectional area of the annular die opening to obtain the DDR. The higher the DDR, the faster the line speed for a given extrusion rate, so the desire from a productivity standpoint is to use the highest DDR possible. The same is true for DRB, which as described on the same page 18 as mentioned above, is the draw of the resin on the inside of the molten tube (cone) as compared to the draw of the resin on the outside of the tube. The DRB range disclosed in the 2002 product bulletin mentioned above is a range of positive DRB, i.e. wherein the draw of the resin on the outside of the tube as it is drawn down onto the insulated wires is greater than the draw on the inside of the tube.

It is desired that a higher line speed be achieved for the FEP-jacketing of electrical cable. It has been found that the use of higher MFR FEP enables the line speed to be increased somewhat, but as MFR increases, the jacket loses the ability to pass the NFPA-255 burn test (Surface Burning Characteristics of Building Materials). This burn test is more strict that the older burn test, UL-910 (NFPA-262). UL 2424, Appendix A, provides that electrical cables tested in accordance with NFPA-255 must have a smoke developed index (hereinafter Smoke Index) of no greater than 50 and a flame spread index (Flame Spread Index) of no greater than 25.

The problem remains of how to extrude FEP faster as a cable jacket and yet provide such jacket that passes the NFPA-255 burn test.

### BRIEF SUMMARY OF THE INVENTION

The present invention solves this problem by the process for forming plenum cable, comprising melt draw-down extruding a tetrafluoroethylene/hexafluoropropylene copolymer (FEP) composition to form a jacket of said cable on the core of said cable, said composition containing at least about 10 wt % of inorganic filler, said filler being char-forming agent, said extruding being carried out at a draw ratio balance (DRB) of less than 1. This melt draw-down extrusion involves the extrusion of the FEP melt in the form of a tube, and as described above, drawing this tube down onto the core of the cable, this draw down producing the molten cone of polymer described above. The present invention embodies the discovery that contrary to the recommendation that the DRB be considerably positive for FEP jacket formation, the line speed and quality of extrudate (jacket) is improved when the FEP is highly filled and the extrusion is carried out using a negative DRB, i.e. a DRB of less than 1. The extrusion process to form the jacket with the filled FEP composition is very sensitive to DRB. Carrying out the extrusion at a positive DRB of just 1.01 produces a jacket that is too tight on the core, such that the jacket is not strippable, as it must be to form connections, and when the core is twisted pairs of insulated wires, the jacket forms crevices mimicking the irregular topography of the core, which locks the jacket in place, further increasing the difficulty of stripping the jacket from the core.

While high draw down ratio (DDR) is beneficial to increasing line speed, the high DDRs such as 80 to 100:1, used for forming primary insulation on a conductor cannot be reached in the process to form the jacket. DDRs as high as about 40:1 are achievable, however, with the filled FEP compositions used in the present invention. It is preferred, however, that the DDR be at least 10:1 and the preferred DDR about 10 to 20:1 to form the best quality jacket.

According to a preferred embodiment, the filled FEP composition also contains hydrocarbon polymer, which aids in the incorporation of the filler into the FEP during melt blending to form the composition, and thereby facilitates the ability to carry out the extrusion to form the cable jacket at high line speed.

The present invention enables the extrusion process to be carried out at a line speed of at least about 300 ft/min (91.5 m/min). The present invention also enables the cable jacket, and thereby the entire cable to pass the NFPA-255 burn test.

### DETAILED DESCRIPTION OF THE INVENTION

In the FEP used in the present invention, the HFP content will typically be about 9-17 wt %, the remainder being TFE. Preferably, the FEP contains an additional monomer such as perfluoro(alkyl vinyl ether) (PAVE), wherein the alkyl group contains 1 to 4 carbon atoms, such as perfluoro(ethyl vinyl ether) (PEVE) or perfluoro(propyl vinyl ether) (PPVE). The preferred FEP is TFE/HFP/PAVE copolymer, most preferably TFE/HFP/PPVE and TFE/HFP/PEVE copolymer, wherein the HFP content is about 9-17 wt % and the PAVE content is about 0.2 to 3 wt %, the remainder being TFE, to total 100 wt % for the copolymer. The reference to monomer content of the copolymer refers to units derived from the monomer by polymerization.

The melt flow rate (MFR) of the FEP used in the present invention is relatively high, preferably at least about 10 g/10 min, more preferably at least about 15 g/10 min, even more preferably at least about 20 g/10 min, and most preferably, at least about 26 g/10 min, as measured according to ASTM D2116-91a.

The filler is comprised of at least one inorganic compound that forms a char in the NFPA-255 burn test. In the burn test, the agent does not prevent the perfluoropolymer from burning, because the fluoropolymer is not flammable in the burn test. Instead, the agent contributes to formation of a char structure that prevents the total composition from dripping, which would lead to objectionable smoke formation and failure of the burn test. The agent is thermally stable and non-reactive at the melt processing temperature of the composition, in the sense that it does not cause discoloration or foaming of the composition, which would indicate the presence of degradation or reaction. The agent itself has color, typically white, which provides the color of the melt processed composition. In the burn test however, the formation of char indicates the presence of degradation.

The FEP composition used in the present invention is highly filled, the char-forming agent constituting at least about 10 wt % of the composition (total weight of FEP plus filler). The amount of char-forming agent is that which is effective to enable the jacket made from the FEP composition pass the NFPA-255 burn test. Generally the char-forming agent content of the composition need not be more than about 60 wt %. The amount of char-forming agent necessary for the jacket to pass this test will depend on the effectiveness of the particular agent and the MFR of the FEP. Some agents are more effective than others, whereby a relatively small amount of agent will suffice. The agent can consist of a mixture of such fillers. Examples of char-forming agents are zinc molybdate, calcium molybdate, and metal oxides such as ZnO, Al₂O₃, TiO₂, and MgZnO₂. Preferably, the amount of agent in the composition will be about 20 to 50 wt % (of the total weight of the filler plus FEP). Preferably the mean particle size of the char-forming agent is no greater than about 3 μm, and more preferably, no greater than about 1 μm, and no smaller than about 0.05 μm to provide the best physical properties for the composition.

The hydrocarbon polymer when used in the filled FEP composition is used in an amount that is effective to provide the physical properties, such as tensile strength and elongation, desired. The hydrocarbon polymer itself does not provide the improved physical properties. Instead, the hydrocarbon polymer interacts with the filler (char-forming agent) and FEP to limit the reduction in tensile properties that the filler, if used by itself, would have on the FEP composition. Without the presence of the hydrocarbon polymer, the melt blend of the FEP/filler tends to be cheesy in appearance, i.e. to lack integrity, e.g. showing cracks and containing loose, unincorporated filler, especially at higher filler contents which may be necessary for particular char-forming agents to enable the cable jacket made from the FEP composition to pass the NFPA-255 burn test. With the hydrocarbon polymer being present in the FEP composition during melt blending, a uniform-appearing melt blend is obtained in which the entire amount of agent is incorporated into the melt blend. Thus, the hydrocarbon polymer appears to act as a dispersing agent, which is surprising in view of the incompatibility of the FEP and hydrocarbon polymer. Hydrocarbon polymer does not adhere to FEP. Neither does the filler. Nevertheless and surprisingly, the hydrocarbon polymer acts as a dispersing agent for the char-forming agent. The effectiveness of the dispersion effect of the hydrocarbon polymer can be characterized by the tensile test specimen of the composition of the present invention exhibiting an elongation of at least about 100%, preferably at least about 150%. The specimen also preferably exhibits a tensile strength of at least about 1500 psi (10.3 MPa). Preferably these properties are achieved on cable jacket specimens in accordance with ASTM D 3032 under the operating conditions of the tensile testing jaws being 2 in (5.1 cm) apart and moving apart at the rate of 20 in/min (51 cm/min).

The amount of hydrocarbon polymer necessary to provide beneficial effect in the composition will generally be about 0.1 to 5 wt % (based on total weight of FEP, filler, and hydrocarbon polymer), depending on the amount of filler that is present in the composition. Preferably the amount of such polymer present is about 0.5 to 3 wt %, based on the total weight of the three components as specified above.

A wide variety of hydrocarbon polymers that are thermally stable at the melt temperature of the FEP, provide this benefit to the composition. The thermal stability of the hydrocarbon polymer is visualized from the appearance of the melt blend of the composition, that it is not discolored or foamed by degraded hydrocarbon polymer. Since FEP melts at temperatures of at least about 250° C., the hydrocarbon polymer should be thermally stable at least up to this temperature and up to the higher melt processing temperature being used and the residence time in melt processing. Such thermally stable polymers can be semicrystalline or amorphous, and can contain aromatic groups either in the polymer chain or as pendant groups. Examples of such polymers include polyolefins such as the linear and branched polyethylenes, including high-density polyethylene and Engage® polyolefin thermoplastic elastomer and polypropylene. Additional polymers include siloxane/polyetherimide block copolymer. Examples of aromatic hydrocarbon polymers include polystyrene, polycarbonate, polyethersulfone, and polyphenylene oxide wherein the aromatic moiety is in the polymer chain. The preferred polymer is the thermoplastic elastomer, which is a block copolymer of olefin units and units containing an aromatic group, commonly available as Kraton® thermoplastic elastomer. Most preferred are the Kraton® G1651 and G1652 that are styrene/ethylene/butylene/styrene block copolymers containing at least 25 wt % styrene-derived units. The hydrocarbon polymer should have a melting temperature or be melt flowable in the case of amorphous hydrocarbon polymers so as to be melt-blendable with the other ingredients of the composition.

Thus, the preferred composition used in the present invention comprises FEP, about 10 to 60 wt % char-forming agent, preferably about 20 to 50 wt %, and about 0.1 to 5 wt % hydrocarbon polymer, preferably about 0.5 to 3 wt %, to total 100 wt %. The composition can be in the pre-melt blend form (the physical blend of components) or can be melt blended or can be in the form of the jacket molded from the melt blend.

The composition used in the present invention will typically start as a physical mixture of the components, which is then melt blended to disperse the filler in the perfluoropolymer. This melt blending can be part of the melt-fabrication process to produce the final article, e.g. using an extruder that also accomplishes the melt blending prior to the extrusion. Alternatively, the composition can be exposed to two melt blending processes, the first forming molding pellets, each containing all the components of the composition, and the second being the melt fabrication, such as by extrusion, to produce the desired final article. Typically, the two melt blending process approach will be followed because of the flexibility it provides in choice of extrusion equipment for the extrusion practitioner. According to this typical approach, the composition is preferably compounded, such as by using a twin-screw extruder or Buss Kneader® compounding machine, to form molding pellets, each containing all two or three ingredients, as the case may be, of the composition. The molding pellets are a convenient form for feeding to melt processing equipment such as for extruding the composition into the fabricated article desired, such as jacket for (on) twisted-pair cable. The Buss Kneader® operates by melting the polymer components of the composition and shearing the molten composition to obtain the incorporation of the filler into the perfluoropolymer with the aid of the hydrocarbon polymer. The residence time of the composition in this type of melt processing equipment may be longer than the residence time in extrusion equipment. To avoid degradation, the Buss Kneader® is operated at the lowest temperature possible consistent with good blending, barely above the melting temperature of the FEP, while the extrusion temperature can be considerably higher, because of the shorter residence time in the processing equipment.

The composition used in the present invention is especially useful for making the jacket of plenum cable that passes the NFPA-255 burn test. The most common such cable will contain four twisted pairs of insulated wires, but the jacket can also be applied to form cable of many more twisted pairs of insulated wires, e.g. 25 twisted pairs, and even cable containing more than 100 twisted pairs. It is preferred that the wire insulation of the twisted pairs be also made of perfluoropolymer such as FEP. It has been found that when the entire insulation is replaced by polyolefin, the jacketed cable fails the NFPA-255 burn test.

Jacket made of low MFR FEP that passes the NFPA-255 burn test has a low melt flow rate and is limited to a very low line speed in the extrusion/jacket operation, of about 100 ft/min (30.5 m/min). Compositions used in the present invention, notwithstanding their high filler (char-forming agent) content can be extruded as cable jacket at line speeds of at least about 300 ft/min (91.5 m/min), preferably at about 400 ft/min (122 m/min). As mentioned above, line speed is the windup rate for the cable, which is also the speed of the cable core fed through the extruder crosshead to receive the extruded jacket. The rate of extrusion of molten composition is less than the line speed, with the difference in speeds being made up by the draw down ratio (DDR) of the extruded tube of molten composition drawn down in a conical shape to contact the assemblage of insulated wires. Surprisingly, when hydrocarbon polymer is present in the FEP composition forming the jacket, the jacket nevertheless passes the NFPA-255 burn test. This is surprising because the hydrocarbon polymer is flammable and the burn test involves the simultaneous exposure of more than 100 lengths of jacketed cable (containing four twisted pairs of insulated wires) to burning, which provides a substantial quantity of “fuel” in the burn test. The presence of this “fuel” in the burn test does not result in the test being failed.

The composition used in the present invention, while capable of high speed extrusion cable jacketing at relatively low temperatures such as up to 650° F. (343° C.), also produces a smooth jacket, which maintains the positioning the twisted pairs within the jacket, but does not adversely affect electrical properties such as the attenuation of the transmission signal by the cable. The uneven outline (outer surface) of the twisted pairs within the cable should be barely to not at all visible from the exterior of the cable, whereby the outside of the jacket has a smooth appearance not conforming to the topography of the core of twisted pairs of insulated wires. Sometimes this is referred to as a “loose fit” but the fit of the jacket over the twisted pairs is snug enough that the jacket does not slide over the surface of the twisted pairs or outer co-axial conductor, as the case may be, to form wrinkles. Nevertheless, the jacket can be circumferentially cut and stripped from the cable to aid in circuit connectability.

The extrusion of the molten tube of filled FEP composition described above is carried out at a DRB less than 1, the DRB preferably being from about 0.95 to 0.99. The DRB is calculated from the draw ratios at the outer surface of the melt extruded tube (DR1) and the draw ratio at the inner surface of the melt extruded tube (DR2), as follows:

$$\begin{matrix}DR1 = \frac{\begin{matrix}outer diameter of \\ the annular extrusion die\end{matrix}}{outer diameter of the jacket} \\ DR2 = \frac{inner diameter of the annular extrusion die}{\begin{matrix}inner diameter of the jacket ( O . D . of the \\ assemblage of twisted pairs )\end{matrix}} \\ DRB = DR1 / DR2\end{matrix}$$

The DRB is changed from a positive value (at least 1) to a negative value (less than 1 by decreasing the die gap (difference between the outer diameter and inner diameter of the extrusion annulus) by either decreasing the outer diameter of the annular extrusion die or by increasing the diameter of the die tip (the inner diameter of the annular extrusion die). Further information on DRB is disclosed on pp. 18-20 of the DuPont Melt Extrusion Guide mentioned above. The difference between the outer diameter of the annular extrusion die and the outer diameter of the jacket (DR1) reflects the drawing down of the molten tube into the form of a hollow cone of molten polymer composition that comes into contact with the cable core passing through the extrusion crosshead. The same is true for DR2. As the molten cone is draw down onto the cable core, its thickness decreases. The greater the thinning out of the molten cone, the higher the draw down ratio (DDR) and the higher the line speed for a given rate of extrusion. Preferably the DDR for the process of the present invention is at least about 10:1. The presence of the hydrocarbon polymer in the filled FEP composition being extruded can enable the DDR as high as about 30:1 and higher to be reached, but the best results are obtained at a DDR maximum of about 20:1. The most preferred DDR is from about 10 to 18:1. Even at these low DDRs, the rate of extrusion using the compositions described above is high enough that high line speed for jacket formation is achieved.

### EXAMPLES

In the Examples below, three-components (unless otherwise specified) FEP, hydrocarbon polymer, and inorganic char-forming agent, are melt blended together by the following general procedure: The perfluoropolymer compositions are prepared using a 70 millimeter diameter Buss Kneader® continuous compounder and pelletizer. A Buss Kneader® is a single reciprocating screw extruder with mixing pins along the barrel wall and slotted screw elements. The extruder is heated to temperatures sufficient to melting the polymers when conveyed along the screw. All ingredients are gravimetrically fed into the Buss Kneader® from one of the multiple feed ports along the barrel. The Buss Kneader® mixes all the ingredients into a homogeneous compound melt. The homogeneous compound melt is fed into a heated crosshead extruder and pelletized.

The general procedure for forming a jacket of the melt blended composition involves extruding the blend as a jacket over a core of four twisted pairs of FEP-insulated wires to form jacketed cable, using the following extrusion conditions: The extruder has a 60 mm diameter barrel, 30:1 L/D, and is equipped with a metering type of screw having a compression ratio with the respect to the barrel of about 3:1 as between the feed section of the screw and the metering section, i.e. the free volume, that is the volume in the extruder barrel that is unoccupied by the screw, within the screw flights in the feed section are about 3× the volume within the screw flights within the metering section. For a screw of constant pitch, the compression ratio is the ratio of the flight depth in the feed section to the flight depth in the metering section (metering into the crosshead). The application of heat to the extruder barrel starts with 530° F. (277° C.) in the feed section, increasing to 560° F. (293° C.) in the transition section and then to 570° F. (298° C.) in the metering section. The extruder is fitted with a B&H 75 crosshead. The assemblage of four twisted pairs of FEP-insulated wires is fed though the crosshead and out the die tip of the crosshead. The temperature of the molten fluoropolymer at the die surrounding the die tip is 598° F. (314° C.). The outer diameter of the die tip is 0.483 in (12.3 mm) and the inner diameter of the die is 0.587 in (14.7 mm), with the annular space between the die tip and the I.D. of the die forming the annular space through which a molten tube of FEP is extruded and drawn down to coat the assemblage of twisted pairs of insulated wire. No vacuum is used to draw the extruded tube down onto the core of twisted pairs of insulated wires. The draw down ratio is 10:1, the thickness of the jacket being 10 mils, and the draw ratio balance is 0.99. The line speed is 403 ft/min (123 m/min). Changes to this general procedure, if any, are indicated in the Examples.

The fire test chamber (elongated furnace) and procedure set forth in NFPA-255 is used to expose 25 ft (7.6 m) lengths of cable to burning along 5 ft (1.5 m) of the 25 ft length (7.6 m) of the furnace, the furnace being operated according to the instructions set out in NFPA-255. The lengths of cable for testing are placed in side-by-side contact with one another so as to fill the test space above the burner of the furnace with a bed of single thickness cable, and the cable is supported by metal rods spanning the furnace and spaced one foot (30.5 cm) apart along the length of the furnace and the length of the cables. Additional support for the cables is provided by steel poultry netting, such as chicken wire, the poultry netting laying on the metal rods and the cable laying on the poultry netting, as set forth in Appendix B-7.2. A large number of cables, each 25 ft (7.6 m) long, are laid on the poultry netting, side-by-side, as described above, such that for the common 4-pair twisted cable, having a jacket thickness of about 10 mils (0.25 mm), more than 100 of such lengths of cable are tested at one time.

The Flame Spread Index is determined in accordance with Chapter 3, Appendix A of NFPA-255.

The Smoke Index is determined using the smoke measurement system described in NFPA-262 positioned in an exhaust extension of the furnace in which the burn test is conducted. The smoke measurement system includes a photoelectric cell, which detects and quantifies the smoke emitted by the cable jacket during the 10-minute period of the burn test. The software associated with the photoelectric cell reports the % obscuration in the exhaust stream from the furnace in the ten-minute period, and the area under the % obscuration/time curve is the Smoke Index (see NFPA-255, Appendix A, 3-3.4 for the determination of Smoke Index). The Flame Spread Index and Smoke Index are determined on as is lengths of cable, i.e. without slitting the jacket lengthwise or without first exposing the cable to accelerated aging. The chemical stability of FEP enables the tensile and burn results after aging at 158° C. for seven days to be about as good as the results before aging.

The FEP used as the primary insulation on the twisted pairs of wires used in the Examples has an MFR of 28 g/10 min and contains PEVE comonomer as described in U.S. Pat. No. 5,677,404. The same FEP is used in the jacket composition in the following Examples unless otherwise specified.

### COMPARATIVE EXAMPLES

A jacket of just the FEP fails the NFPA-255 burn test. Tensile testing of compression molded plaques (ASTM D 638) of the FEP results in good tensile strength and elongation of 3259 psi (22.5 MPa) and 350%, respectively.

A jacket of the FEP and Kraton® block copolymer elastomer (1 wt %) fails the NFPA-255 burn test.

Addition of 30 wt % Kadox® 930 ZnO to the composition in the preceding paragraph and extrusion at a DRB of 1.01 instead of 0.99 produces a cable jacket that passes the NFPA-255 burn test, but is unsuitable because it is too tight, having the appearance of mimicking the topography of the core twisted pairs of wires.

In this following Examples of the present invention, a number of compositions are described, each containing FEP, char-forming agent, and hydrocarbon polymer (unless otherwise indicated), each forming test articles exhibiting good physical and electrical properties, and each capable of being extruded at a line speed exceeding 300 ft/min at the low melt temperature specified above as a jacket over twisted pairs of insulated wires, with the resultant jacketed cable passing the NFPA-255 burn test.

### Example 1

The composition 100 parts of FEP, 3.5 parts Kraton® G1651 thermoplastic elastomer, and 30 parts calcium molybdate, mean particle size less than 1 μm, to total 133.5 parts by weight, is melt blended and then extruded. Tape samples tested in accordance with ASTM D 412 (5.1 cm/min) exhibit a tensile strength of 1460 psi (10.1 MPa) and elongation of 150. Test samples also exhibit good electrical and nonflammability properties, as follows: dielectric constant of 2.64 and dissipation factor of 0.004 (ASTM D 150) and a limiting oxygen index (LOI) of greater than 100% (0.125 in sample (3.2 mm)). The lower the dielectric constant, the better; generally a dielectric constant of 4.0 or less is considered satisfactory. These test procedures are used in the succeeding Examples unless otherwise indicated.

### Example 2

The composition 100 part FEP, 30 parts Kadox® 920 ZnO mean particle size 0.2 μm, 3.5 parts Kraton® G1651 thermoplastic elastomer is melt blended and extruded. Tape samples exhibit the following properties: tensile strength 1730 psi (11.9 MPa) and elongation 225%. Test samples also exhibit good electricals and non-flammability: dielectric constant of 2.5, dissipation factor of 0.007, and LOI of greater than 100%.

### Example 3

The composition of 100 parts FEP, 3.5 parts Kraton® G1651, and 30 parts ZnO (Kadox® 920), and 5 parts calcium molybdate is melt blended and extruded. Tape samples exhibit tensile strength of 1792 psi (12.3 MPa) and elongation of 212%. Dielectric constant is 2.72, dissipation factor is 0.011 and LOI is greater than 100%.

### Example 4

The composition of 100 parts FEP, 1 part Kraton®, and 66.66 parts of Onguard® 2 (MgZnO₂) is melt blended and extruded to give good extrudate, i.e. smooth to form a tough jacket.

### Example 5

The composition 100 parts FEP, 5 parts Engage® polyolefin, and 20 parts Mg(OH)₂/zinc molybdate (Kemguard® MZM) is melt blended and extruded, and its test samples exhibit tensile strength of 1850 psi (12.8 MPa), elongation of 153% and LOI of 91%.

### Example 6

The composition 100 parts FEP, 1.5 parts Kraton® G1651 and 75 parts Cerox® 502 ZnO, mean particle size of 2.2 μm, is melt blended and extruded to give good extrudate. Tensile testing on rod samples (51 cm/min) gives tensile strength of 2240 psi (15.4 MPa) and elongation of 215%.

### Example 7

The composition of 100 parts FEP, 3 parts DGDL3364 (Dow Chemical high density polyethylene), and 75 parts Cerox® 506 ZnO is melt blended and extruded to give good extrudate. Test rods exhibit tensile strength of 1830 psi (12.6 MPa) and elongation of 110%, which is good for rod samples.

### Example 8

The composition of 100 parts FEP, 2.5 parts Siltem® 1500 (dried) (siloxane/polyetherimide) block copolymer, and 75 parts Cerox® 506 ZnO is melt blended and extruded to give good extrudate, Test rods exhibit tensile strength 1700 psi (11.7 MPa) and 170% elongation.

### Example 9

The composition 100 parts FEP, 5 parts Lexan® 141 polycarbonate, 5 parts Kraton® G1651 elastomer, and 50 parts Cerox® 506 ZnO is melt blended and extruded to give good quality extrudate. Rod test samples exhibit tensile strength of 2245 psi (15.5 MPa)and 300% elongation.

### Example 10

The composition of 100 parts FEP, 1 part Lexan®D 141 polycarbonate, and 75 parts Cerox® 506 ZnO is melt blended and extruded to give good quality extrudate.

### Example 11

The composition of 68 wt % FEP, 2 wt % Kraton® G1651 thermoplastic elastomer, and 30 wt % Al₂O₃ is melt blended and tested for MFR, which is better for the composition (32.3 g/10 min) than the FEP by itself (MFR 31.125 g/10 min). The composition gives good extrudate.

### Example 12

A jacket having the following composition: FEP 100 parts, aromatic hydrocarbon elastomer (Kraton® G1651) 1 part per hundred parts (pph) FEP, and 66.66 pph Kadox® 930 ZnO (mean particle size 0.33 μm (total weight of composition is 176.66 parts), is formed. The jacket has a wall thickness of 9-10 mil (0.23-0.25 mm) and the overall cable has a diameter of 0.166 in (4.2 mm) and forms a snug fit (exhibiting a cylindrical appearance, not conforming to the topography of the core twisted pairs of insulated wires) over the 4 twisted pairs of insulated wire in the cable. 121 lengths of this cable are simultaneously subjected to the burn test under NFPA-255, with the result being a Flame Spread Index of 0 and a Smoke Index of 29. The surface of the jacket is smooth and the tensile strength and elongation of rod samples of the composition are 2235 psi (15.4 MPa) and 165%, respectively. The tensile properties of the jacket itself are tested in accordance with ASTM D 3032, wherein a length of jacket is cut circumferentially and is slipped off the cable to form the test specimen. The test conditions are a spacing of 2 in (5.1 cm) between the tensile tester jaws, and the jaws being pulled apart at the rate of 20 in/min (51 cm/min). The jacket specimen so-tested exhibits a tensile strength of 2143 psi (14.8 MPa) and elongation of 301%. The jacket also exhibits a dielectric constant at 100 MHz of 3.32. When the burn test is repeated on this cable after aging at 158° C. for 7 days, it exhibits a Flame Spread Index of 0 and Smoke Index of 25.

When this experiment is repeated except that the FEP insulated twisted pairs of conductors are replaced by polyethylene-insulated twisted pair conductors, the cable burns the length of the furnace during the NFPA-255 burn test. This is a failure due to the combustibility of the polyethylene insulation.

### Example 13

The NFPA-255 burn test is carried out on a cable wherein the jacket has the following composition: 100 parts FEP, 3.5 pph Kraton® 1551G, and 100 pph Cerox®-506 ZnO (meanparticle size less than 1 μm), to total 203.5 parts. The jacket wall thickness varies from 7-13 mils (0.18-0.33 mm) and the cable thickness is 0.186 in (4.7 mm). 108 cable lengths are tested in the burn test, and the result is Flame Spread Index of 0 and Smoke Index of 23.

### Example 14

Similar results to Example 12 are obtained when the jacket composition is 100 parts FEP, 2.6 pph Kraton® G1651, and 75 pph Cerox® 506 ZnO, to total 177.6 parts, and the jacket wall thickness is 10 mil (0.25 mm) and the cable diameter is 0.186 in (4.7 mm). 108 lengths of the cable are tested in the NFPA-255 burn test, and the results are Flame Spread Index of 0 and Smoke Index of 30.

### Example 15

Results similar to Example 12 are obtained when the jacket composition is as follows: 100 parts FEP, 3.5 pph Kraton® G1651, and 50 pph Cerox® 506 ZnO, to total 153.5 parts, and the jacket wall thickness is 8 mils (0.2 mm) and the cable diameter is 0.156 in (4 mm). 129 lengths of cable are tested in the NFPA-255 burn test, and the results are Flame Spread Index of 0 and Smoke Index of 25. The jacket also exhibits a dielectric constant of 3.6 at 100 MHz.

### Example 16

Results similar to Example 12 are obtained when the jacket composition is: 100 parts FEP, 3.5 pph Kraton® G1651, and 30 pph Kadox® 920 ZnO, to total 133.5 parts, and the jacket wall thickness is 7 mils (0.18 mm) and the cable diameter is 0.169 in (4.3 mm). 119 lengths of cable are tested in the NFPA-255 burn test and the results are Flame Spread Index of) and Smoke Index of 40.

### Example 17

The general melt-blending procedure is applied to a two-component composition in this Example. A composition of FEP and 30 wt % ZnO (Kadox® 930), to total 100 wt %, reduces the MFR of the FEP to 20-22 g/10 min, and compression molded plaques exhibit less than desired tensile properties: tensile strength of 1536 psi and elongation of only 106%. These properties are improved by using less ZnO in the composition, and the reduced concentration of the ZnO is still sufficient for the jacket made from the composition to pass the NFPA-255 burn test.

1. A process for forming plenum cable, comprising melt draw-down extruding a tetrafluoroethylene/hexafluoropropylene copolymer (FEP) composition to form a jacket of said cable on the core of said cable, said composition containing at least about 10 wt % of inorganic filler, said filler being char-forming agent, said extruding being carried out at a draw ratio balance (DRB) of less than 1.

2. The process of claim 1 wherein said melt draw-down extruding drawing down is carried out at a draw-down ratio (DDR) of up to about 40:1.

3. The process of claim 1 wherein said amount of filler is at least about 20 wt %.

4. The process of claim 1 wherein hydrocarbon polymer is also present in said composition.

5. The process of claim 4 wherein the amount of said hydrocarbon polymer in said composition is about 0.1 to 5 wt %.

6. The process of claim 1 wherein said melt-draw-down extruding is carried out at a line speed of at least about 300 ft/min (91.5 m/min).
